(19) United States
(12) Patent Application Publication
(10) Pub. No.: US 2010/0097207 A1
(43) Pub. Date: Apr. 22, 2010

(54) ACTIVATION DEVICE FOR PERSONAL ALARM SYSTEM

(76) Inventors: Stephen Mildenberger, Tangier (CA); Peter Miller, Chicago, IL (US); Kaine J. S. Mildenberger, Toronto (CA)

Correspondence Address: George H. Gerstman;Seyfarth Shaw LLP, Suite 2400, 131 S. Dearborn Street, Chicago, IL, 60603, US

(21) Appl. No.: 12/574,516

(22) Filed: Oct. 6, 2009

Related U.S. Application Data
(60) Provisional application No. 61/196,228, filed on Oct. 16, 2008.

(51) Int. Cl. G08B 1/08

(52) U.S. Cl. 340/539.11

(57) ABSTRACT

A personal alarm is provided which comprises a flexible card adapted to be carried by a user. The personal alarm includes a power source, a transmitter, and an activation component that is activated in response to bending or folding of the personal alarm. The activation component is coupled to the transmitter. In this manner, bending or folding of the personal alarm will activate the transmitter and the signal from the transmitter will be transmitted to activate an alarm.

### RELATED APPLICATION

This application claims the benefit of priority of provisional application Ser. No. 61/196,228, filed Oct. 16, 2008. All of the disclosure of provisional application Ser. No. 61/196,228 is incorporated herein by reference.

### BACKGROUND OF THE INVENTION

### A. Overview of Personal Alarms

A personal alarm (also known in the literature by many other names, some of which include ‘Personal Portable Alarm’, ‘Body Alarm’, ‘Panic Alarm’, ‘Duress Alarm’, and ‘Emergency Alarm’, is a device carried by a person to signal for assistance in an emergency situation. Many methods of communicating an alarm to others are familiar to those in the alarm industry. Some devices create a loud sound to attract nearby persons and perhaps to scare off a potential attacker. Some emit chemicals such as pepper spray. Others transmit signals, such as an infrared or an ultrasonic or a radio frequency or a microwave signal or some combination of these signals, with or without an audible signal. The transmitted signals typically arrive at one or more receiving devices that are part of a system to notify others that the person needs assistance.

The received notification message might include sufficient information to determine the identification and/or the location of the person needing assistance. The methods of communicating the alarm from the receiving device(s) to its final destination are many and varied, and many methods are known to the alarm industry. Some examples of methods that might be used individually or in combination are point-to-point communications links, ‘landline’ telephone networks, cellular telephone networks, microwave networks, satellite networks, commercial wired and/or wireless networks and proprietary wired and/or wireless networks.

Personal alarms may also provide a signal to the user that the device has been activated. This may include one or more of an audible sound, a vibration of the device or other tactile feedback, or a light source of some form.

Personal alarm systems might protect persons who are at risk of being assaulted. Prison guards in correctional institutions and persons walking to cars in dark parking lots at night are two examples of persons who might use such systems. Persons working alone in areas where they might become ill or injured, and persons with medical conditions who might need emergency help, are examples of others who might use personal alarms to signal for assistance.

### B. Activating Personal Alarms

Many methods have been conceived to activate personal portable alarms. The most common method is by activating a button, lever or switch. Pulling a pin from the personal alarm (often named ‘pull-pin’ or ‘bayonet pull’ or ‘lanyard pull’) is also common. Automated activation of the personal alarm is sometimes used for persons who might not be able to activate an alarm. One common automated activation method is a ‘man down’ or tilt detection device that is intended to recognize when a person's orientation changes from an upright to a prone position. Another automatic activation is a ‘no-motion’ detector that activates an alarm if the person does not move for a defined duration of time. A third activation method detects the personal alarm being removed from the person, perhaps by cutting the attachment strap or removing a clip from a belt or pocket. Manual and automatic alarm activation methods are frequently combined to meet specific requirements.

### C. Nuisance Alarms

Most personal alarm activation methods are prone to some level of nuisance alarms. A nuisance alarm is defined here and in some of the literature as an alarm that is unintentionally activated, but where such activation can be explained. Accidentally bumping the activation button of an alarm device is an example of a nuisance alarm. This is in contrast to false alarms that occur with no identifiable cause, or alarms that are intentionally activated by a user when there is no emergency situation. Much of the literature does not distinguish between nuisance alarms and false alarms, and includes nuisance alarms in the category of false alarms.

Nuisance alarms can occur for many reasons. An alarm button may be bumped accidentally, a cord attached to a pull-pin may be snagged, a ‘man-down’ alarm on a person's belt may be activated when the device is inadvertently placed in a horizontal orientation. Some systems and some methods of alarm activation are much more prone than others to the occurrence of nuisance alarms.

The minimization of nuisance alarms is important for any alarm system. The impact of nuisance alarms is greater where the response resources and effort to respond to an alarm are large or lengthy. As an example, much effort and cost is expended to respond to a ‘mayday’ alarm from a researcher in the arctic or a climber on a mountain who needs help.

Nuisance alarms have a large impact in systems where many persons carry personal alarms. In a system where 20,000 people carry personal alarms, a nuisance alarm rate of one alarm per year per alarm device would result in more than 50 nuisance alarms per day. Response resources are not available for a real emergency while they are responding to a nuisance alarm. As well, emergency response organizations often will stop responding to alarms when many nuisance alarms occur, increasing the probability that a real alarm will not receive an appropriate response. Thirdly, users may stop carrying their personal alarms if they find that the devices are generating nuisance alarms and the users become the object of unintended alarm responses.

One challenge in the design of any alarm system is to minimize the nuisance alarm rate while also minimizing the chance that a real alarm will not be activated. For example, a button might be recessed or made smaller so that it is less likely to be activated accidentally, reducing the probability of a nuisance alarm. However, this design may make it harder for the user to reach the button quickly in an emergency, thereby reducing the probability that a real alarm can be generated. This is one example of many tradeoffs that are made in the design and operation of an alarm system to minimize nuisance alarms without unduly increasing the risk that a valid alarm will not be activated.

### D. Personal Alarm Activation Difficulties and Tradeoffs

A personal alarm is intended to enable a person to signal for help in an emergency. The person may be an uninvolved witness, for example to an automobile accident, assault or other incident. The person may be the object of a threatening situation such as an assault. In reference to the latter case, it is known that many people under extreme stress approach a state of panic and lose most fine motor coordination abilities. For example see, “Psychological Effects of Combat” by Dave Grossman and Bruce K. Siddle, Academic Press, 2000. In such a situation, it may become difficult or impossible to activate a button or switch or lever on a personal alarm, particularly if it is recessed or covered or otherwise protected from accidental activation. Keying a code, such as 911, into a telephone keypad may be impossible. If the alarm device has a button on only one side, the simple action of determining the button location by touch and orienting the device so that the person's finger can press the button may be next to impossible. Since time usually is of the essence in an emergency, the person will attempt to perform these actions very quickly, further increasing the probability of failing to activate an alarm.

Alarm devices commonly are activated by pressing a button. When such devices are carried on a lanyard around the neck, or on the belt, the button tends to be bumped into door frames, corners of tables and cabinets, and other objects. This causes unintentional alarm activation called a nuisance alarm. When carried in pockets, purses, and briefcases, personal alarms are bumped and pressed by other carried objects. Many attempts have been made to reduce this nuisance alarm problem by requiring two or more buttons to be pushed simultaneously or in a sequence, however, nuisance alarms can still occur. As well, the more complex activation process in an emergency requires more skill and attention. Many designs of the button and the personal alarms package have been offered. Each solution provides a tradeoff between reduced probability of rapid activation in an emergency, and an increased probability of nuisance alarms.

Various complex methods of protecting buttons from accidental activation have been devised. The button can be recessed in a hole or depression in the personal alarm. The button can have a cover that must be displaced or a release mechanism that must be moved before the alarm can be activated. Such solutions do reduce nuisance alarms, but at the cost of making activation of the personal alarm more complex or difficult. In a life threatening emergency, when many people totally lose fine motor control, these more complex designs only make it less likely that a person will be able to activate such devices in a timely manner, if at all.

Alarm devices may be activated by pulling a pin from the device. This pin is prone to accidental removal. It also can be difficult to find and pull in an emergency. Often a cord or lanyard is attached to the pin to simplify the activation process, but this cord can be snagged or entangled on objects or hands, resulting in accidental activation and additional nuisance alarms.

Personal alarms with buttons or pull-pins must be in specific orientations so that the activation device can be reached for activation. A button only can be pressed after the personal alarm is turned so that the side with the button faces the thumb or finger that will activate the alarm. In an emergency, a threatened person often may not have the coordination or the presence of mind to manipulate the orientation of a personal alarm before activating it. Requiring a two-stage activation, for example activating two or more buttons in sequence, or activating a release latch or moving a protective cover before pressing the button, only increases the risk that an alarm will be delayed or, worse yet, not activated at all.

### E. User Must Carry the Personal Alarm

A personal alarm must be with the user when assistance is required. It does no good in an emergency if the personal alarm is left at home, left in a car, or is otherwise distant from the user. It may also be of no use if it is carried in a briefcase where it cannot easily be reached, or in a purse that may be taken in an assault. To maximize the probability that the personal alarm will be reached easily at times when it may be required, it is important to minimize the inconveniences of having the personal alarm with the user at all times.

A high risk of nuisance alarms is one reason why a person may choose to not carry a personal alarm at certain times or at all times. Fear of accidentally summoning police or a security force can be a major deterrent to carrying the alarm device.

A user might also leave a personal alarm behind if there is no convenient place to carry the alarm device. If the personal alarm is large, or heavy, or aesthetically displeasing, or an awkward shape, or otherwise hard to carry without special clips or attachments, then the user will be inclined to not carry it. If a special or additional action or procedure is required, outside of the user's everyday routine, then the personal alarm may be forgotten or ignored or deliberately left behind.

### BRIEF DESCRIPTION OF THE INVENTION

Several of the disadvantages of existing personal alarms can be overcome by employing a personal alarm in the general form of a card similar to a credit card or an ID badge. It is activated by folding the personal alarm as illustrated in the Figures. Advantages include:
a) Reduced nuisance alarms—the personal alarm is not likely to be activated accidentally, because it is not likely to be folded unintentionally even if it is carried in a pocket, purse, briefcase or wallet. Reduced nuisance alarms increase the likelihood that there will be an alarm response because response staff will have much more confidence that the alarm is real. Response staff also will be more available because they won't be chasing nuisance alarms while real emergencies go unattended. Finally, reduced nuisance alarms give users more confidence and users will be more likely to carry their personal alarms.
b) Increased probability of activation—the act of folding an object, for example by closing the hand, is a gross motor movement that can be accomplished even by someone in a state of panic. Thus users have a higher probability of being able to activate an alarm in an emergency situation.
c) A personal alarm in the convenient and familiar format similar to a credit card or ID badge is more likely to be carried by the user. Because this personal alarm is less prone to false alarms and more likely to be activated in a real emergency, users will be further inclined to carry the personal alarm at all times.
d) The above advantages result in the most important advantage for users as well as response staff and the community—users will be safer; risk of property loss, injury, and even death will be reduced; and consequent direct and indirect costs will be minimized.

Many embodiments of the alarm device are possible. It can be a single use device that can be carried for years, and then activated when required. This embodiment would be ideal for university students who will rarely use the device but need it to be functional in an emergency situation. It could be a reusable device that can be activated multiple times over its useful life. Police and security persons, who can be trained to recharge batteries and regularly test their personal alarms are good candidates for this embodiment.

The alarm transmissions could be RF signals, as are used in many existing personal alarm systems. Ultrasonic signals, infrared signals, or a combination of transmitted and received signal types might be employed if the folding personal alarm is to be integrated with existing systems in order to provide existing users of traditional personal alarm systems with the benefits of this personal alarm. The alarm device could communicate signals compatible with almost any commercial personal alarm system.

The power source for the personal alarm could be a single use battery that is never used except in an emergency and that is always ready at full capacity until an alarm is activated. A multiple use personal alarm could use a rechargeable power source. This format would require the user to be trained and to be disciplined so as to ensure that the battery is always recharged adequately so that an alarm can be transmitted when required. Clients of a reusable system include police, security guards, prison correctional officers, and military personnel.

A piezoelectric transducer that is flexed to generate energy and activate an alarm could be employed in a multiple use device to eliminate the need to recharge a power source, while a piezoelectric transducer that is stressed until it breaks to generate energy might be suitable for a single use personal alarm in certain applications.

In some embodiments, the alarm device could vary in shape and size and texture to make it easier to recognize by touch amongst other cards, or to make it easier to hold, particularly for the elderly or for persons with physical disabilities.

In some embodiments the alarm transmission may occur once or multiple times, and at equal or varying intervals to suit the anticipated emergencies or to be compatible with existing systems.

In all of these embodiments, the method of communication, the power source, the internal activation mechanism, the alarm transmission medium and patterns, and the physical details of the shape and surface of the device can be implemented and configured to suit the application and the intended users, using skills well known to those familiar with electronic design and packaging and familiar with personal alarm systems. Nevertheless, in all embodiments the folding of the personal alarm to initiate an alarm, a method that is novel and previously unknown, will confer the benefits listed above that are not achieved by any other alarm activation device.

The application of this device, as discussed above, is as a personal alarm. The method of activation, bending or folding a card, could also be used in applications not related to alarms. It could be applied to any device that could benefit from a hand-held activator as an alternative to a button, pull-pin, switch, or other means of activation.

In accordance with one embodiment, a personal alarm is provided that comprises a flexible card adapted to be carried by a user. The card includes a power source, transmitter circuitry, and an activation component. The activation component is coupled to the transmitter, whereby bending or folding of the personal alarm will cause the transmitter to be activated and an alarm signal will be transmitted from the transmitter.

Folding of the personal alarm to activate an alarm is not prone to nuisance alarms and does not require fine motor coordination, thus removing two of the largest problems inherent in other alarm activation devices. A card is also a convenient and familiar object that a person is likely to carry at all times.

### BRIEF DESCRIPTION OF THE DRAWINGS

FIG. 1A is a front diagrammatic view of a personal alarm in accordance with the principles of the present invention;

FIG. 1B is a side diagrammatic view thereof;

FIG. 1C is a side diagrammatic view of a personal alarm in activated condition in accordance with the principles of the present invention;

FIG. 2A is a front diagrammatic view of the internal functional blocks of the embodiment of FIG. 1 for a single use personal alarm.

FIG. 2B is a side diagrammatic view thereof.

FIG. 3A is an electronic circuit of a single use personal alarm, detailing the activation components.

FIG. 3B is the equivalent functional block for the activation components of FIG. 3A.

FIG. 4 is a simplified electronic circuit for a single use personal alarm, employing the activation component functional block of FIG. 3B.

FIG. 5A is a front diagrammatic view of the structure of the activation component.

FIG. 5B is a side diagrammatic view thereof.

FIG. 6 is a personal alarm electronic circuit with an inductively powered testing circuit.

FIG. 7 is a flow chart showing the logic to choose between a test transmission and a real alarm transmission.

FIG. 8A is a diagrammatic front view of the functional blocks of a reusable personal alarm.

FIG. 8B is a side diagrammatic view thereof.

FIG. 9 is the functional electrical blocks of a personal alarm including a battery charging circuit.

### DRAWINGS REFERENCE NUMBERS

1—Personal Alarm
31—Diode
32—Three terminal load switch
33—Resistor
34—Resistor
35—Input signal to load switch
36—Input power to load switch
37—Switched output of load switch
38—Activation component
40—Personal alarm encapsulation material
41—Transmitter antenna
42—Electrical conductors
43—Transmitter circuitry
44—Activation circuitry functional block
45—Power source
51—Regulated Power Supply
52—Inductive loop
53—Logic input for test function
54—Pull-down resistor
55—Diode
56—Transmitter power input
71—IR emitter
72—IR detector
73—Logic output to control IR emitter
74—Logic input to read IR detector
75—Spring to cause personal alarm to return to unfolded shape.
76—Rubber encapsulation material
77—Plastic encapsulation material
78—Lens
81—Power supply and battery charger Functional Block
82—Blocking diode
91—Metallic block for electrical connection
92—Conductive material
93—Ceramic or brittle plastic substrate
94—Metallic block for electrical connection
95—Metallic block for electrical connection
96—Metallic block for electrical connection
97—Conductive material

### DETAILED DESCRIPTION OF THE ILLUSTRATIVE EMBODIMENTS

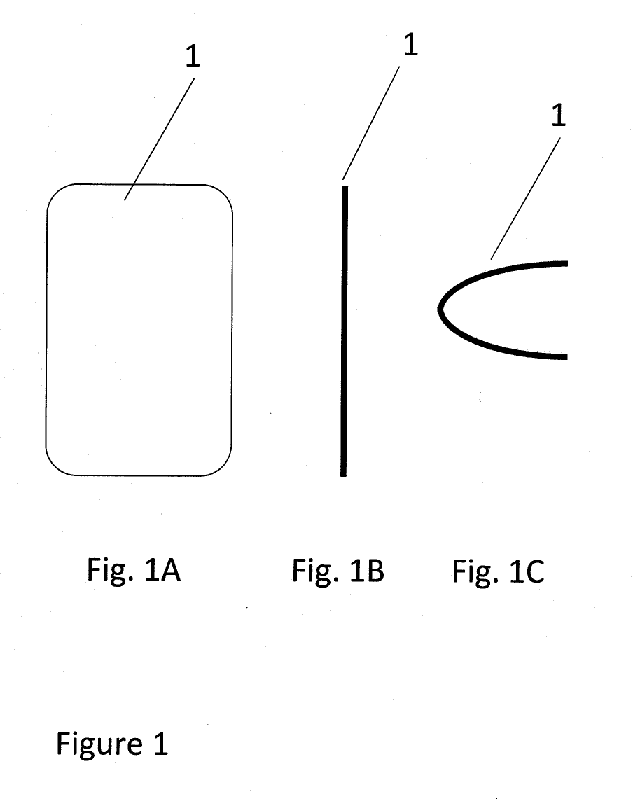

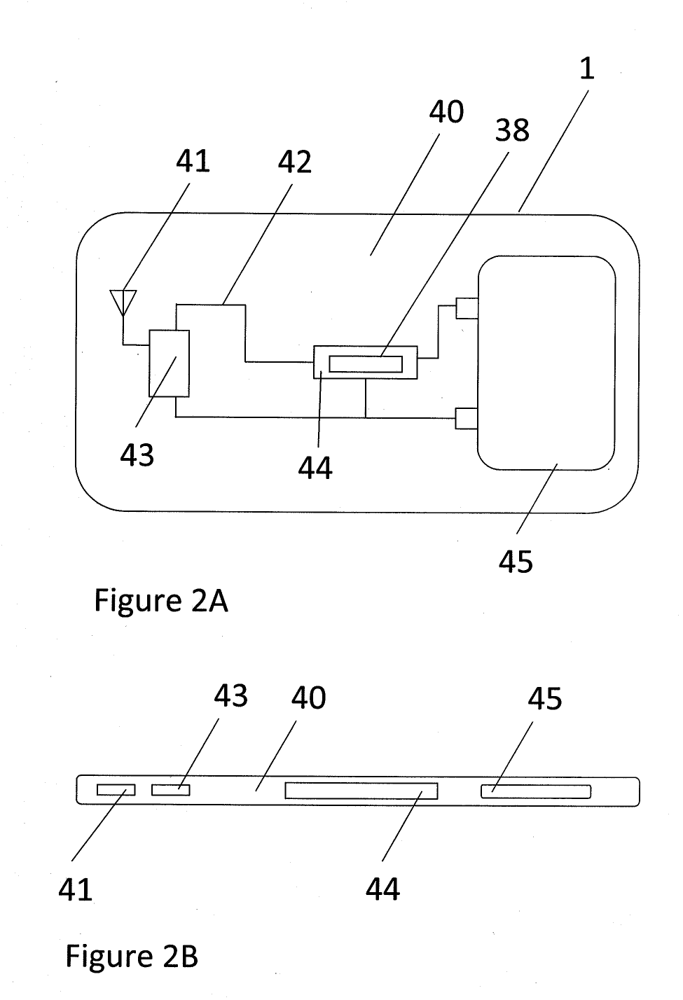

Referring to FIGS. 1A, 1B and 1C, a personal alarm 1 is illustrated in a form of a flexible card in the general form of an I.D. (identification) card or credit card. As illustrated in FIG. 1C, activation of said personal alarm 1 is achieved by folding said personal alarm 1 until it deforms to the point where an internal activation component 38 in FIG. 2A is activated and turns on the alarm. The personal alarm 1 construction is such that the electronic and mechanical components associated with alarm activation and alarm transmission are all internal to the personal alarm 1 and are not visible to the user.

FIG. 2A is the major internal components of the personal alarm1 in a front view. FIG. 2B shows an edge view of the personal alarm 1. The transmitter circuitry 43, coupled to an RF antenna 41, provides transmitting an alarm. A power source 45 powers the transmitter circuitry 43 when an electrical circuit to the power source 45 is completed through the activation circuitry 44 and electrical conductors 42.

The activation circuitry 44 includes an activation component 38. Activation component 38 is positioned across the center folding point of the personal alarm 1 as seen in FIGS. 2A and 2B. Thus when the personal alarm 1 is folded as seen in FIG. 1C, the activation component 38 is folded because it is encapsulated within the personal alarm 1 at the location of maximum folding of the personal alarm 1. An electrical connection within the activation circuitry 44 is closed when the personal alarm 1 and its internal activation component 38 are folded. The closed connection through activation circuitry 44 completes a circuit between the power source 45 and the transmitter circuitry 43. Transmitter circuitry 43 is then powered up and transmits an alarm signal that is radiated from antenna 41.

Activation circuitry 44, including activation component 38, can be co-located in one device but it is not necessary. If a certain manufacturer's processes made it simpler to separate the activation component 38 and the remaining circuitry of activation circuitry 44, then the remaining circuitry could be located elsewhere on the card, except for the activation component 38 that must be placed across the center folding line of the personal alarm 1. Activation component 38 may comprise a plurality of activation components that are strategically located so that one or more will break when the card is bent or folded at least a predetermined amount.

With respect to drawing 2A, the activation component 38 is positioned in the center of the personal alarm 1 and oriented as shown in FIG. 2A so that it is folded and thus activated when the personal alarm 1 is folded. With respect to FIG. 2B, the activation component 38 is placed across the center folding line of the card so that the folding force on the activation component 38 will be of the same force, regardless of whether the personal alarm 1 is folded in an upwards or in a downwards direction. Flexible conductors 42 are used to connect components within the personal alarm 1. The exact internal location of the power source 45, the transmitter circuitry 43 and the antenna 41 within the personal alarm 1 can be varied to accommodate other manufacturing processes and the characteristics of selected components.

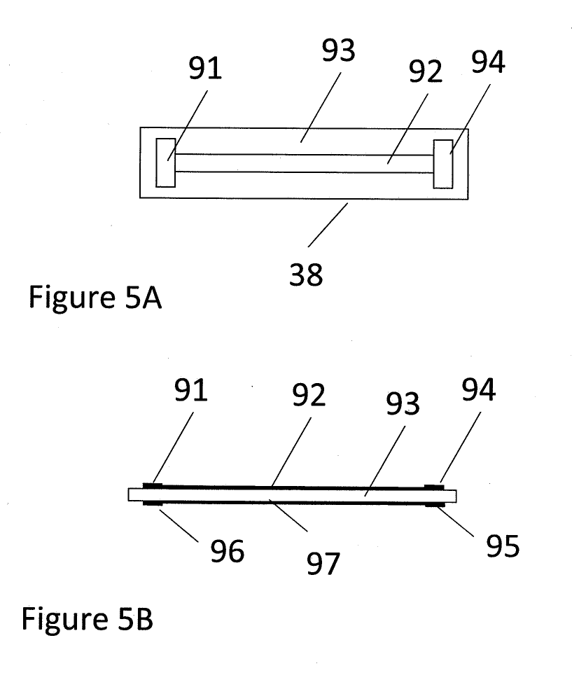

The structure of the activation component 38 is shown in FIGS. 5A and 5B. The activation component 38 has a substrate 93 made of brittle, electrically non-conducting plastic or of a ceramic material. Electrical conductors 92 and 97 are attached to opposite sides of substrate 93. Industry standard thick film, thin film, inkjet printing or other techniques can be used to apply the conductors.

Metallic Blocks 91, 94, 95, and 96 are electrical attachment points for connecting the activation component 38 to the remainder of the activation circuitry 44 or to connect activation component 38 to other conductors or to a printed circuit board in the personal alarm 1.

Conductors 92 and 97 provide an electrical path between the attachment points 91, 94, 95, and 96. When the activation component 38 is folded as a result of the personal alarm 1 being folded, the substrate 93 is broken, causing an electrical break in conductors 92 and 97. This open electrical circuit causes activation circuitry 44 to apply power to the transmitter circuitry 43.

The two electrical conductors 92 and 97 are connected in series, for example by connecting attachment 94 to attachment point 95, then by connecting attachment point 91 and attachment point 96 to the activation circuitry. In this way, if either conductor 92 or conductor 97 is broken, an open circuit will occur that will activate the personal alarm 1. The purpose of connecting the two conductors 92 and 97 in series is that when the personal alarm 1 is folded and the substrate is broken, the conductors on either side of the break may remain touching because they may be pressed together on the concave side of the personal alarm 1. However the conductors on the convex side of the personal alarm 1 will be forced apart, causing an electrical open circuit and activating the activation circuitry 44 to cause an alarm to be transmitted. Thus the personal alarm 1 can be folded in either direction to activate an alarm.

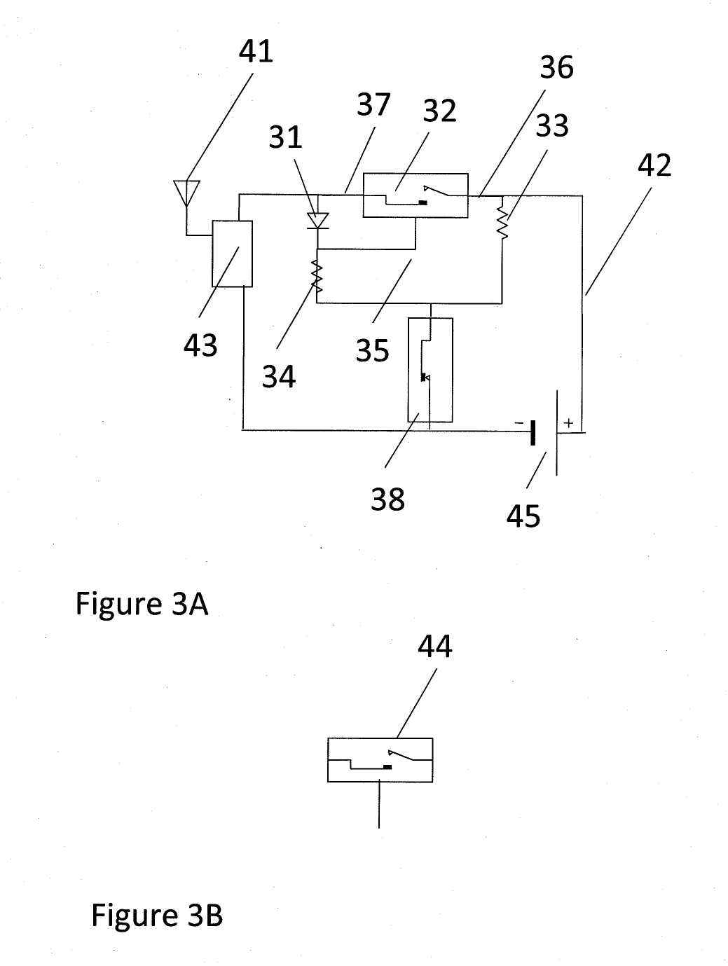

FIG. 3A is the electrical circuit of the personal alarm 1 with details of the alarm activation circuitry. FIG. 3B shows the equivalent three terminal representation of this circuitry that includes the activation component 38.

With respect to FIG. 3A, a load switch 32 is used to switch power to the transmitter circuitry 43. A load switch in this context is a small three-terminal device designed for switching on power to portable and battery operated devices. Such devices are available from a number of semiconductor manufacturers. The power source 45 is connected to input terminal 36. When control input 35 is switched high, power is connected to output terminal 37 of load switch 32.

Before the personal alarm 1 is activated, activation component 38 is a closed circuit and it holds input 35 low through resistor 34. Output 37 is an open collector when input 35 is low, so output 37 and resistor 34 have negligible effect on the circuit. Current flows from the power source 45 through resistor 33 and activation component 38. Resistor 33 is of a high value, approximately equal to the input resistance of input 35. A typical value for resistor 33 would be 10 Megohms and current flow would be 200 nanoamperes.

When the personal alarm 1 is activated, activation component 38 is broken and becomes an open circuit. Current then stops flowing through activation component 38. The voltage at input 35 will rise. Diode 31 is chosen to have very low reverse current leakage, so current flowing through resistor 33 will be limited by the input resistance of input 35. By choosing the value of resistor 33 to be approximately equal to the input resistance of input 35, the voltage at input 35 will be approximately half of the voltage of the power source 45.

The voltage at input 35, that is, approximately half the voltage of the power source 45, is well above the voltage required to switch on the load switch 32. As a result, the voltage at output 37 rises to the power source 45 voltage. This causes the diode 31 to become forward biased and the input to the load switch 32 is held high. As a result, the load switch 32 is latched on.

It is possible that after the personal alarm 1 will be unfolded or otherwise flexed by the user after an alarm has been activated. Although unlikely, this could result in an electrical connection being re-made through activation component 38. Were this to happen, current would flow through diode 31, resistor 34, and the activation component 38. Resistor 34 would limit this current to a small value, perhaps 200 microamps. Because diode 31 is forward biased, input 35 would remain high and the load switch 32 would remain latched on.

With reference to FIGS. 2A and 2B, personal alarm 1 is covered with a plastic encapsulation material 40. The transmitter circuitry 43, antenna 41, power source 45, activation component 38, and conductors 42 are encapsulated into the personal alarm 1 using a commercially available cold encapsulation process. This technique is offered commercially and is used to make some varieties of ‘smart cards’. The mold for the encapsulating material 40 defines the final size and shape of the personal alarm 1. The mold might use the exact form of a standard credit card or an ID badge, or it might vary in thickness, surface texture, and dimensions to accommodate specific component sizes, manufacturing processes, and user preferences.

Following encapsulation, the personal alarm 1 is imprinted with the desired imagery, which might include the user's photograph, ID information, or simply a company name and logo. A variety of industry standard techniques are used for applying images to ID cards, credit cards and other similar cards.

In this embodiment the activation circuitry 44 closes an electrical circuit when the personal alarm 1 is folded, thus connecting the power source 45 to the transmitter circuitry 43 and powering the transmitter circuitry 43. When power is applied to the transmitter circuitry 43, it will operate and will transmit an alarm message that is radiated through antenna 41. The alarm message may include a unique ID code for the individual personal alarm 1, to identify the user. The alarm message may also contain diagnostic information about the personal alarm 1 such as the status of the power source 45.

For the generation of RF transmissions, transmitter circuitry 43 employs a small integrated circuit transmitter chip such as is offered by Texas Instruments or Analog Devices or other vendors. Transmitter circuitry 43 includes additional components attached to the transmitter chip as specified in the transmitter chip manufacturer's data sheets and application notes for the selected device. Additional components that are part of the transmitter circuitry 43 may include crystals, capacitors, resistors, inductors, a microprocessor chip, and other control circuitry familiar to those skilled in the design and implementation of such circuitry.

The transmitter circuitry 43 is connected to an RF antenna 41 to emit the RF alarm transmission. Many designs are possible for the antenna 41. The choice of the antenna 41 is a function of the RF power level required, the RF operating frequency of the transmitter circuitry 43, and other factors well known to those skilled in antenna design and selection. A wire loop antenna or an integrated circuit chip antenna can be encapsulated in the personal alarm 1.

The RF transmissions generated by the alarm circuit 43 and emitted by antenna 41 are received by compatible alarm receivers to implement the alarm response.

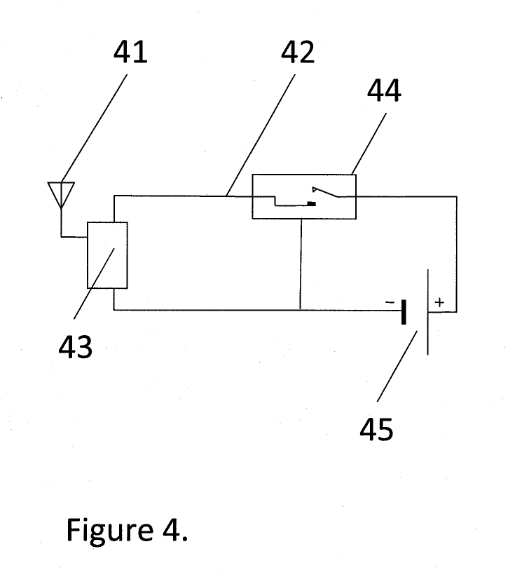

The equivalent schematic of the electronic circuitry for the personal alarm 1 is shown in FIG. 4. A power source 45 provides power to alarm circuitry 43 when the activation circuitry 44 is activated by folding the personal alarm 1 as shown in FIG. 1C. The circuit is completed though electrical conductors 42. When powered, transmitter circuitry 43 transmits an alarm through antenna 41.

The personal alarm 1 in this embodiment is not a reusable device. After the activation component 38 in activation circuitry 44 is activated, the transmitter circuitry 43 will continue to operate until the power source 45 is depleted or until the transmitter circuitry 43 completes of a predetermined number of alarm transmissions.

As stated above, one embodiment of a personal alarm 1 is illustrated in FIG. 1A (front view) and FIG. 1B (edge view). The personal alarm 1 is in the general form of a flexible card adapted to be carried by a user. With reference to FIGS. 2A and 2B, the personal alarm 1 includes a power source 45, alarm transmission circuitry 43 with an antenna 41, and activation circuitry 44 that is activated in response to bending or folding of the personal alarm 1. The activation circuitry 44 is coupled to the transmitter circuitry 43, whereby bending or folding of the personal alarm 1 will activate the transmitter circuitry 43 and an alarm signal from the transmitter circuitry 43 will be transmitted through antenna 41 to activate an alarm. These components may all be disposed on a flexible circuit board, as is known in the art.

The user closes his/her hand firmly over the personal alarm 1 to fold it, as illustrated in FIG. 1C, and thus to activate the alarm. Closing the hand is a gross motor movement that can be accomplished even when fine motor coordination is lost through fear or panic. Such a gross motor activation of the personal alarm 1 dramatically increases the probability that an alarm can be activated in an emergency, because it does not require fine motor motions such as finding and pushing a button. The personal alarm 1 can be folded in either direction. It does not require any visual or fine tactile clues to recognize a front or back or top or bottom of the personal alarm 1 in order to activate it. It does not require the release of a protected switch or button. A slight flexing of the personal alarm 1 will not cause activation, but folding the personal alarm 1 by a predetermined amount will activate the personal alarm 1.

The action of closing the hand to activate the personal alarm 1 is very fast, simple, and reliable. The probability of an alarm being activated, and the speed at which it can be activated, are both increased, when compared with traditional alarm devices. The result is reduced risk and improved safety for the user. As well, some elderly persons and some persons with physical handicaps will be able to protect themselves by using this personal alarm 1 whereas they might not have the manual dexterity or flexibility to be able to activate a personal alarm with a button or switch.

Upon activation, the personal alarm 1 will emit a radio frequency alarm signal compatible with the intended alarm receiver(s). The alarm transmission may be repeated multiple times until the power source 45 is depleted or until a predetermined number of transmissions are achieved. The received alarm signals are processed and used to initiate the desired alarm response. Some familiar alarm responses are summoning persons, turning on cameras, activating lights or audible alerts, and opening or closing locks.

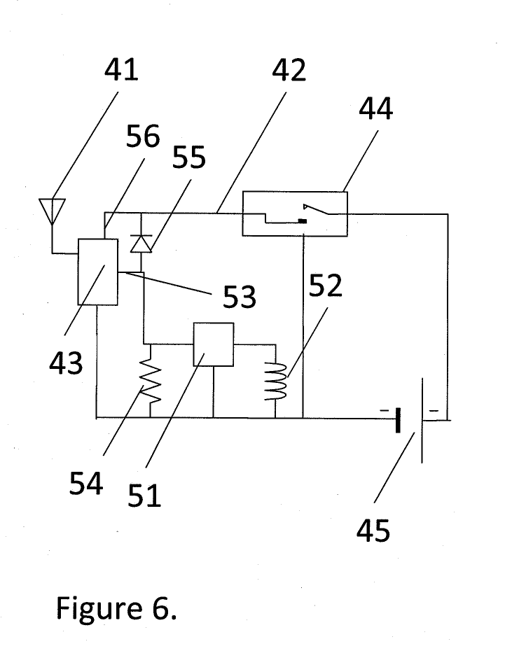

Another embodiment is similar to the first embodiment, plus it includes the addition of a circuit that allows the personal alarm 1 to be tested without drawing significant power from its internal power source 45. With reference to FIG. 6, the Input to the regulated power supply 51 is an inductive loop 52 encapsulated in the personal alarm1 that generates an alternating current when placed in a suitable alternating RF field. This field is encountered when the personal alarm 1 is inserted into a special personal alarm tester that generates the required RF field and reads a unique RF transmission from the personal alarm 1 that verifies its functionality. Such technology with inductive loops is familiar to those who design circuitry for proximity cards in the security industry.

AC current that is induced in the inductive loop 52 is rectified and converted to a regulated direct current of suitable voltage for the transmitter circuitry 43, using power supply techniques very well known in the electronics industry. The output of the regulated power supply 51 is presented to a signal input 53 of the transmitter circuitry 43. It is also presented to the power input 56 of the transmitter circuitry 43 through a diode 55. When the personal alarm 1 is inserted in a tester, transmitter circuitry 43 is powered up and a high logic level at the signal input 53 will be detected. When a high logic level is present at signal input 53 and the transmitter circuitry 43 is powered, the transmitter circuitry 43 will cause a test transmission, rather than a valid alarm transmission, to be generated.

If the transmitter circuitry 43 is powered by folding the personal alarm 1, as would occur in a real emergency situation, then power passes through activation circuitry 44. Diode 55 blocks the voltage from the power source 45 and the signal input 53 is held at a logic low level by a resistor 54. When the transmitter circuitry 43 is powered up by its internal power source 45, the low signal at the signal input 53 causes the transmitter circuitry 43 to issue a valid alarm transmission.

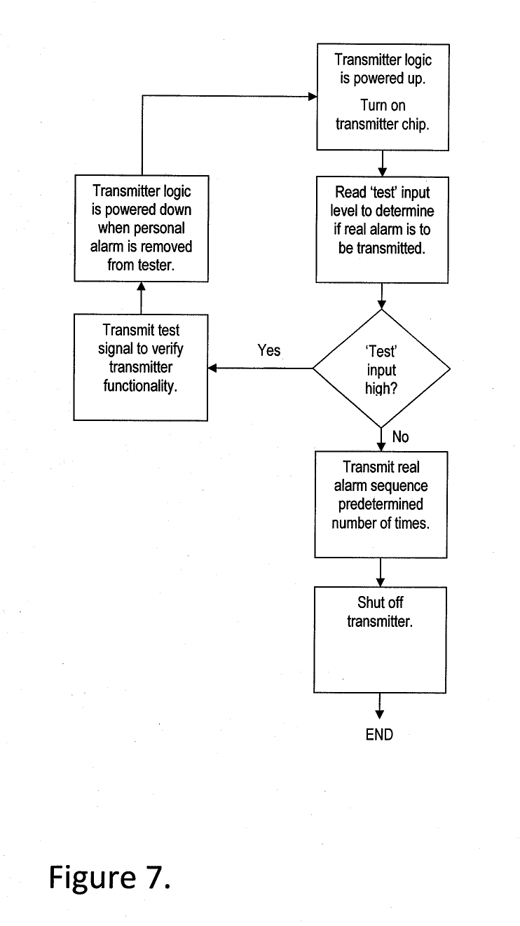

FIG. 7 is a flow chart showing the logical steps for the transmitter circuitry 43 to follow in order to choose between sending a test transmission and a real alarm transmission.

In this embodiment, the personal alarm 1 of the first embodiment also contains a circuit that allows the user to test the personal alarm 1 and verify its functionality. To test the personal alarm 1, the transmitter circuitry 43 is powered up using an external source of energy as shown in FIG. 6. The personal alarm 1 is inserted into a personal alarm tester. The personal alarm tester generates an RF field that is captured by an inductive loop 52 in the personal alarm 1 in order to power up the transmitter circuitry 43 without consuming power from the internal power source 45 of the personal alarm 1.

The personal alarm 1 will transmit a test alarm message when it is inserted in the personal alarm tester. This message is analyzed by software in the tester and the tester indicates to the user the functionality of the personal alarm 1.

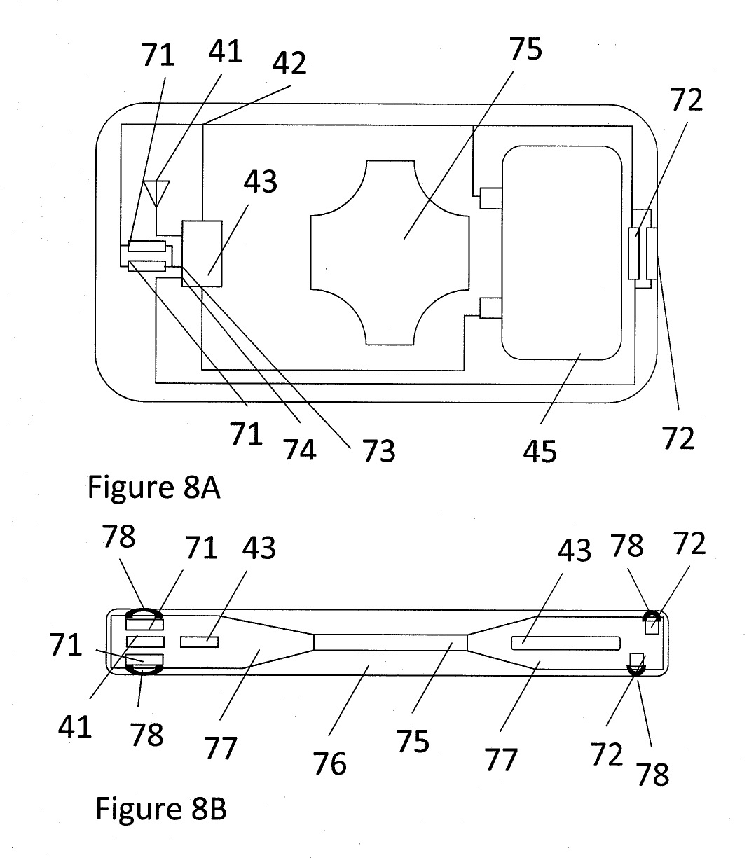

Another embodiment is a personal alarm 1 that can be used multiple times before it is discarded. The user of this embodiment will fold the personal alarm 1 to activate an alarm, as described in the first embodiment. When the folding force on the personal alarm 1 is released, the personal alarm 1 will return to its flat, unfolded shape. FIG. 8 shows the major functional blocks of this reusable personal alarm 1. In the center portion of the personal alarm 1, where it will be folded, is a metal spring 75. The spring 75 is molded into the personal alarm 1 when the package is encapsulated. The strength of the spring 75, determined by its thickness and its material properties, will determine the force required to fold the personal alarm 1.

The personal alarm 1 encapsulation process includes first encapsulating the components of the personal alarm 1, except in the area near the center of the card where the personal alarm 1 folds, with a standard plastic encapsulation material 77 that covers the electronic devices and wires. The entire personal alarm 1 is next encapsulated in a rubber encapsulation material 76 similar to what is used to coat ruggedized cell phones. This encapsulation material 76 is flexible and durable so that it will survive the folding of many activations of the personal alarm 1. The resulting personal alarm 1 is thicker than a standard credit card or ID badge. It is rugged and suitable for use by police, corrections, and other staff performing daily security functions.

When the reusable personal alarm 1 is in normal operation, the transmitter circuitry 43 applies an output signal at output 73 to the IR emitters 71 located on opposite faces at one end of the personal alarm 1. The transmitter circuitry 43 monitors the IR detectors 72 through a logic input 74. The IR detectors 72 are on opposite faces of the personal alarm 1, at the opposite end of personal alarm 1 from the IR emitters 71. The IR detectors 72 are covered with simple lenses 78 that collect light. IR emitters 71 and IR detectors 72 are covered with lenses 78 that are masked during the encapsulation process so that these devices are not covered with encapsulation materials 76, 77. The amount of indirect light from the IR emitters 71, when reflected off of surfaces is inadequate to activate the IR detectors 72 and to thus initiate an alarm. When the personal alarm 1 is folded in either direction, one IR emitter 71 and one IR detector 72 are brought very close to each other and their surfaces now face each other, allowing a sufficient amount of light to enter the IR detector 72 from the IR emitter 71 so that the signal can be detected by the transmitter circuitry 43.

The transmitter circuitry 43 switches the IR emitters 71 on and off in a unique pattern. The transmitter circuitry 43 then monitors the signals from the IR emitters 72. The encoded pattern of received light pulses read from an IR detector 72 by the transmitter logic circuitry 43 must match the pattern of transmitted pulses created for the IR emitters 71 by the alarm circuitry 43 before an alarm transmission will be initiated. This prevents false alarms that might be created by signals from another personal alarm 1 or from other IR devices.

When the folding force on the personal alarm 1 is released, it returns to its flat position and the signal at the IR detector 72 disappears. This is recognized by the transmitter circuitry 43. A predetermined alarm transmission sequence is completed and the personal alarm 1 is then ready to be used again.

The reusable personal alarm 1 will consume power to operate its IR devices and to generate alarms. The power source 45, unlike the power source 45 in a single use device, will gradually be depleted over time even though no alarm might be transmitted.

Police, military personnel, security guards, and prison corrections officers will test their personal alarms 1 at least once per shift and might use a personal alarm 1 multiple times within, a short period of time. It becomes uneconomical for them to discard a personal alarm 1 each time it is used. As well, some may need to use the personal alarm 1 a second time during a time where a replacement device is not available. Additional functions such as man-down and detection of an alarm being removed from the person may be required. These can be costly additions to a personal alarm 1 that the purchasers of these devices will not want to throw away each time the personal alarm 1 is used. Such functions also demand energy from the power source 45 and they can only be used for long periods of time if the personal alarm 1 can be recharged.

The reusable personal alarm 1 will need to be recharged on a regular basis. Most personnel in police, military, and security employment are familiar with recharging equipment. Unlike the general public, they are also available for training and can be taught the importance of always recharging their personal alarms 1.

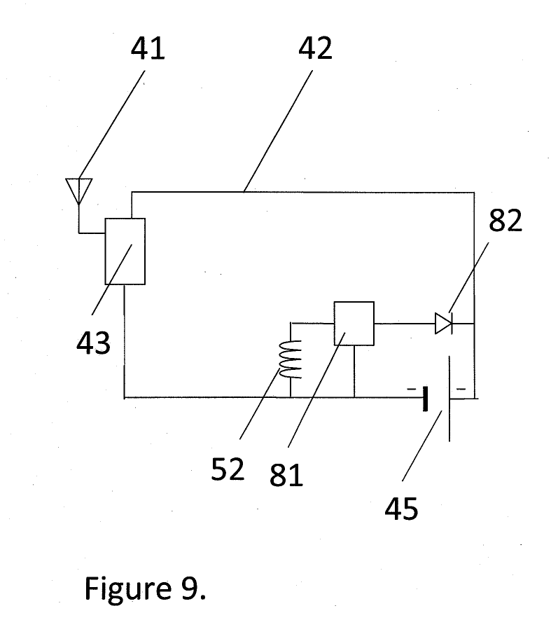

A block diagram including a charger circuit is shown in FIG. 9. To recharge the personal alarm 1, the personal alarm 1 is inserted into a personal alarm charger. The personal alarm 1 contains an inductive loop 52 that collects energy from an RF field produced by the charger. This is the same process as has been described for powering up the single use personal alarm 1 to test it. The inductive loop 52 is used as an energy collector for the charger. The power supply and charger circuit 81 is connected across the power source 45. Very sophisticated single chip power conditioning devices are available to provide optimized charging currents, times, and patterns for particular battery types, if the power source 45 is a battery. A blocking diode 82 ensures that the charger does not draw power from the power source 45 when the inductive loop 52 is not powering the charger.

In this embodiment, the personal alarm 1 is a reusable device and is not discarded after one use. It contains a rechargeable power source 45 internal to the personal alarm 1. To recharge the personal alarm 1, the user inserts the personal alarm 1 into a charger that supplies energy to the device through an inductive loop 52. No other action is required on the part of the user.

In one embodiment, a method for initiating a personal alarm 1 is provided. The method comprises the steps of providing a flexible card 40 having a power source 45 and transmitter circuitry 43. The flexible card 40 carries components to change a circuit connection and thus to activate the transmitter circuitry 43 when the card 40 is deformed a predetermined amount by the user.

In one embodiment, a method for testing the power source 45 is provided. The transmitter circuitry 43, before causing transmitter circuitry 43 to issue a test transmission as described in the second embodiment, will momentarily connect a voltage measuring input in the transmitter circuitry 43 to the power source 45 by activating a mechanical or solid state switch. Thereby the personal alarm 1 can measure its supply voltage and report its status to the user as part of the test transmission from the personal alarm 1. Using similar techniques, other information internal to the personal alarm 1 can be reported when the personal alarm 1 is tested.

In one embodiment, the personal alarm 1 contains a method of notifying the user that an RF transmission has been sent. This notification can be by use of an LED or LCD display or an audible alarm or a vibration of the personal alarm 1.

In one embodiment, the RF transmitter circuitry 43 is replaced with RF transceiver circuitry so that the personal alarm 1 is not only able to transmit messages to the alarm receivers, but is also able to receive messages from the alarm system. Such messages would, for example, permit the personal alarm 1 user to receive acknowledgement that an alarm was received by the system or that help is on the way. Messages transmitted from the alarm system can be displayed to the user of the personal alarm 1. The display might be a flashing LED light or an LCD display. It might be an audible alarm through a piezoelectric transducer, similar to a watch alarm, that is included as part of the circuitry.

In one embodiment, an infrared transceiver and control circuitry is included in the personal alarm 1. In this way, the personal alarm 1 can be made to operate with existing systems using a mixture of IR and RF. Users of these existing systems could be provided with increased safety by using a folding personal alarm 1.

In one embodiment, the personal alarm 1 employs one or two ultrasonic transducers as the alarm power emitter, replacing the conventional RF antenna 41 in the first embodiment. This is consistent with the alarm emission format used by some vendors of personal alarm systems. In this way, the personal alarm 1 would operate as an alarm input to existing ultrasonic personal alarm systems and provide an improved activation method for the user.

The personal alarm 1 could be a very low powered device that transmits its alarm signal to a larger device carried by the user. The larger device would relay the alarm signal at higher power and could translate it into other formats, or other forms such as infrared or ultrasonic. In this way the personal alarm1 could be very low powered so that it could operate for a much longer period of time if activated as a single use device. It would need recharged less often when in the form of a reusable device.

In one embodiment, a piezoelectric power source 45 is employed. The piezoelectric power source 45 generates energy when it is flexed or broken, and this energy operates the transmitter circuitry 43. In this embodiment the piezoelectric device could be both the power source 45 and the activation component 38.

In one embodiment, the personal alarm 1 is combined with one or a plurality of other functions unrelated to alarms, such as ID cards, smart cards, access control cards, magnetic stripe cards, or proximity reader cards.

In one embodiment, the personal alarm 1 is in the form of a flexible card 40, similar or identical in shape and flexibility to a credit card or a typical ID badge issued by, for example, employers, institutions and government departments.

In one implementation, the personal alarm 1 is in the form of a card that differs in size and shape from a standard credit card. The card can be larger or smaller. It can be in the shape of a company logo or a letter of the alphabet or other shape that the purchaser may choose. The only restriction is that the shape must allow a user to activate an alarm quickly and easily and reliably by folding the flexible card. The texture and thickness, in addition to the size and shape of the personal alarm 1, can differ from that of a standard credit card to accommodate features and functionality, plus aesthetic and corporate preferences. The personal alarm 1 might be slightly longer or wider than a standard ID card or credit card so that it is easier to identify by feel in the dark or inside a purse or pocket. It might be thicker to accommodate additional components or to change its mechanical characteristics when folded. It might have a textured surface or textured edges, again to make it easier to identify. Special textured edges could make the personal alarm 1 easier to hold and activate for people wearing gloves and for certain persons with physical handicaps. The personal alarm 1 might be square, with the ability to be folded on either axis (length or width) to activate an alarm, adding slightly more probability of successful alarm activation in an emergency. A round, disc-shaped personal alarm 1 could also be used. The personal alarm 1 could be imprinted with a personal photograph, ID number, name, corporate logo, and other information, using industry standard techniques. The convenience and attractiveness of this personal alarm 1 will increase the probability that the user will carry it and have it available for use in an emergency. Thus the user's safety is maximized, and the user's risk is minimized.

Although illustrative embodiments of the invention have been shown and described, other substitutions and modifications may be made without departing from the spirit and scope of the invention.

That which is claimed:

1. A personal alarm which comprises:
a flexible card adapted to be carried by a user;
said card including a power source, a transmitter, and an activation component that is activated in response to bending or folding of the card;
the activation component being coupled to the transmitter whereby bending or folding of the card will activate the transmitter and the signal from the transmitter will be transmitted to activate an alarm.

2. A personal alarm as defined in claim 1, in which the alarm circuit is activated when the card is deformed by the user a predetermined amount.

3. A personal alarm as defined by claim 1, in which said activation component is breakable in response to bending or folding of the card.

4. A personal alarm as defined by claim 1, further comprising a plurality of activating components positioned to enable the transmitter to be activated if the card is bent or folded in either direction.

5. A personal alarm as defined by claim 1, in which the flexible card is encapsulated in plastic.

6. A personal alarm as defined by claim 1, in which the activation component is made of plastic that will flex under normal use but will break when the flexible card is purposely bent or folded.

7. A personal alarm as defined by claim 1, in which the activation component completes a closed circuit path under normal use but creates an open circuit when the card is bent or folded.

8. A personal alarm as defined by claim 7, including a switch that is in an off state when the circuit path is closed and it is on an on state when the circuit path is open; the switch being located between the power source and the transmitter, whereby the transmitter will be activated when the card is bent or folded.

9. A personal alarm as defined by claim 1, including a circuit that is normally in an off state when the card is normal use, and it is an on state when the card is bent or folded.

10. A personal alarm as defined by claim 9, the activating component being breakable when the card is bent or folded, whereby the circuit is placed in an on state.

11. A personal alarm as defined by claim 1, in which the card has the general dimensions of a standard I.D. card or credit card.

12. A personal alarm as defined by claim 1, in which the card carries a device for confirming an alarm transmission.

13. A personal alarm as defined by claim 1, in which the transmitter is an RF transceiver.

14. A personal alarm as defined by claim 1, in which the power source comprises a piezoelectric power source that generates energy when it is flexed or broken, with the piezoelectric power source operating to power the transmitter.

15. A personal alarm which comprises:
a flexible card adapted to be carried by a user;
said card including a power source, a transmitter, and an activation component;
the activation component being activated in response to bending or folding of the card;
the activation component being coupled to the transmitter whereby bending or folding of the card will activate the transmitter and the signal from the transmitter will be transmitted to activate an alarm;
the activation component completing a closed circuit path under normal use but creating an open circuit when the card is bent or folded.

16. A personal alarm as defined by claim 15, including a switch that is in an off state when the circuit path is closed and is in an on state when the circuit path is opened; the switch being located between the power source and the transmitter, whereby the transmitter will be activated when the card is bent or folded.

17. A personal alarm as defined by claim 15, in which the power source comprises a piezoelectric power source that generates energy when it is flexed or broken, with the piezoelectric power source operating to power the transmitter.

18. A method for initiating a personal alarm which comprises the steps of providing a flexible card having a power source and a transmitter, with the flexible card carrying components to change a circuit connection and activate an alarm circuit when the card is deformed at least a predetermined amount by the user.
